(19) United States
(12) Patent Application Publication
(10) Pub. No.: US 2005/0282417 A1
(43) Pub. Date: Dec. 22, 2005

(54) USB hub

(76) Inventor: Robert Tsao, Taipei (TW)

Correspondence Address: BIRCH STEWART KOLASCH & BIRCH, PO BOX 747, FALLS CHURCH, VA, 22040-0747, US

(21) Appl. No.: 10/871,415

(22) Filed: Jun. 18, 2004

(51) Int. Cl. H01R 13/44

(52) U.S. Cl. 439/131

(57) ABSTRACT

This invention relates to an improved Universal Serial Bus (USB) hub, whose housing comprises a USB upstream port to which is connected a host computer, a plurality of expandable USB downstream ports to which are connected external peripherals, and an outlet by which a power source is provided; wherein, the housing comprises at least one groove in which a rotatable USB downstream port is set. The rotatable USB downstream port is able to vertically circle upward from the groove, convenient for small-scale peripherals to plug in. Besides, it can be stored horizontally into the groove on the housing after rotating 90-degree downward. The improved USB hub is space-saving, convenient for plugging in and pleasing to the eyes.

### BACKGROUND OF THE INVENTION

1. Field of the Invention

The present invention generally relates to an improved USB hub, and more particularly to a USB hub, whose USB downstream port is able to vertically rotate upward from a groove on a housing, convenient for small-scale peripherals to plug in. It can also be stored horizontally into the groove on the housing after rotating 90-degree downward. The improved USB hub is space-saving, convenient for plugging in and pleasing to the eyes.

2. Description of the Prior Art

Science and technology change with each passing day and some inventions are unexpectedly created. Through Hi-Tech, we enjoy better quality of life and fulfill some tasks which required a large number of manpower in the past. The speed of computer processing and data operating accelerates due to the improvement of microprocessor. This makes computer peripherals connected to a host also increases. However, the host does not provide ports with various specifications. In order to connect to various peripherals, a host has at least a USB port. The connectors of the present peripherals, therefore, are USB ports in order to achieve the goal of plug-and-play.

However, since the USB port provided by a computer is limited, USB hub is used to increase the number of the ports. While the capability of the USB hub being enhanced, the look-and-feel of the hub is usually neglected. At present, a plurality of wired USB connectors, and wireless peripherals such as portable disc, transceivers (like Bluetooth) all plug into the USB hub. Under this circumstance, the related cables may be confusing or tangled, which not only causes plug-in inconvenient but also makes the scenes disorderly and unsightly.

### SUMMARY OF THE INVENTION

In view of the drawbacks of the traditional USB hub, the inventor(s) try their best to improve the structure of the hub. With their experiments for years, an improved USB hub is then created. The characteristics of this improved USB hub are that a rotatable USB downstream port is able to vertically rotate upward from a groove, convenient for small-scale peripherals to plug in. It can also be stored horizontally into the groove on the housing after rotating 90-degree downward. The improved USB hub is space-saving, convenient for plugging in, and pleasing to the eyes.

The main objective of the present invention is to provide an improved USB hub whose USB rotatable downstream port is able to vertically rotate upward from the groove, convenient for small-scale peripherals to plug in. It can be stored horizontally into the groove on the housing after rotating 90-degree downward. The improved USB hub is space-saving, convenient for plugging in and pleasing to the eyes.

To achieve the above-mentioned objectives, the structure of the USB hub is improved as follows: an improved USB hub, whose housing comprises a USB upstream port to which is connected a host computer, a plurality of expandable USB downstream ports to which are connected peripherals, and an outlet by which a power source is provided; wherein, the housing comprises at least one groove in which a rotatable USB downstream port is set. The rotatable USB downstream port is able to vertically circle upward from the groove, convenient for small-scale peripherals to plug in. It can also be stored horizontally into the groove on the housing after rotating 90-degree downward. The improved USB hub is space-saving, convenient for plugging in, and pleasing to the eyes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded view of a USB hub according to the present invention.

FIG. 2 is an assembled view of a USB hub according to the present invention.

FIG. 3 is a side cross view of a USB hub showing the state of use according to the present invention.

FIG. 4 is another side cross view of a USB hub showing the state of use according to the present invention.

### DETAILED DESCRIPTION OF THE PREFERRED EMBODIMENT

For examiners' better understanding, the invention is explained in detail by showing embodiments and drawings as below:

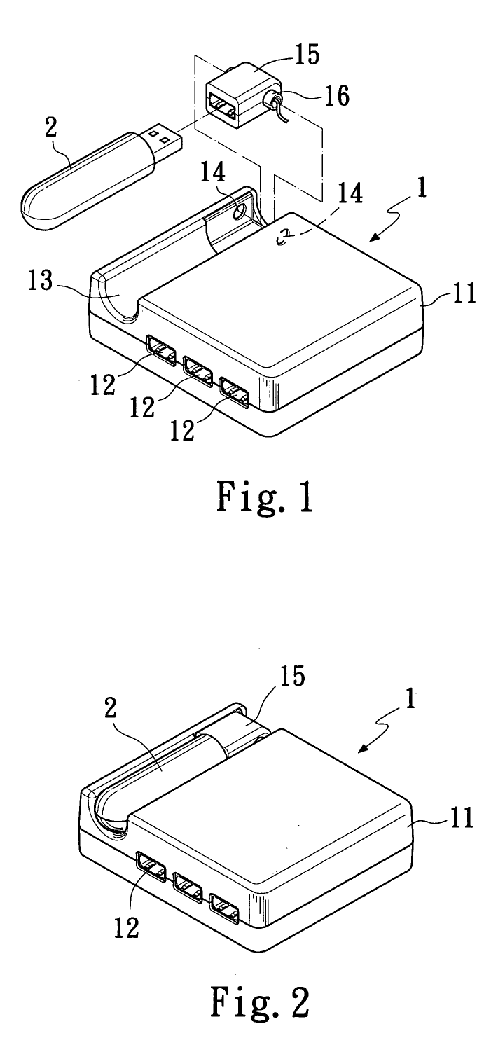

Referring to FIGS. 1-4 that show an exploded view, an assembled view and side cross views 1 and 2 of the invention. As shown, a USB hub 1 whose housing 11 comprises a USB upstream port (not shown) to which is connected a host, three expandable USB downstream ports 12 to which are connected peripherals, and an outlet (not shown) by which a power source is provided; wherein, at least one groove 13 is concavely positioned on the housing 11; holes 14 are positioned respectively at two sides of the groove 13; a rotatable USB downstream port 15 is positioned in the groove 13; protruding shafts 16 are positioned respectively at two sides of the rotatable USB downstream port 15; the protruding shafts 16 are pivotally installed in the holes 14; the rotatable USB downstream port 15 can rotate in either way of from front to rear or from right to left, and vice versa. A predetermined space and shape of the groove 13 are for horizontally storing the peripherals 2 on the groove 13. (The invention reveals the pivotal relationship of the shafts 16 and the holes 14 for both sides of the groove 13 to present a rotation in either way of from front to rear or from right to left, and vice versa;) however, the design of the rotating structure is not limited to the above, it can also be a cardan joint combined with a sphere and a spheroid groove to achieve an all-round turn purpose.

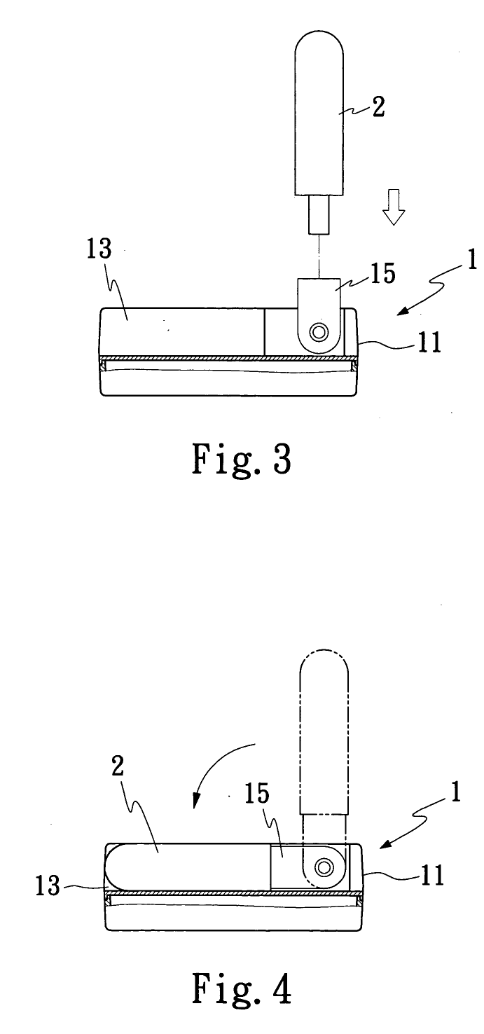

According to the invention, while USB hub 1 connecting with peripherals 2, the horizontal rotatable USB downstream port 15 on the groove 13 turns upward so that the peripherals 2 can be plugged in (as shown in FIG. 3). After that, the rotatable USB downstream port 15 is then stored in the groove 13 (as shown in FIG. 4). In addition, a Bluetooth apparatus can be separately set in the host and USB hub 1; USB hub 1 can be located anywhere connecting to other peripherals; the host at the other side can be connected to other peripherals by means of the Bluetooth apparatus to achieve the purposes of space-saving, convenient for plugging in, and pleasing to the eyes.

As mentioned above, the improved USB hub provides industrial applicability, nonobviousness and novelty, which meet the requirements of the invention and thus deserve a patent.

Although a particular embodiment of the invention has been described in detail for purposes of illustration, coverage of this patent is not limited thereto. On the contrary, this patent covers all embodiments of the teachings of the invention falling fairly within the scope of the appended claims, either literally or under the doctrine of equivalents.

1. (canceled)

2. The improved USB hub as claimed in claim 5, wherein holes are positioned respectively at two sides of said groove; protruding shafts are located respectively at two sides of the rotatable USB connection port; the protruding shafts are pivotally installed in the holes; the rotatable USB connection port can rotate in either way of from front to rear or from right to left, and vice versa.

3. The improved USB hub as claimed in claim 5, wherein the groove is for horizontally storing the peripherals on the groove.

4. The improved USB hub as claimed in claim 5, wherein the rotatable USB connection port and the groove can be a sphere and a spheroid groove respectively to make a cardan joint which is able to achieve an all-round turn.

5. An improved USB hub having an upstream port for connecting to a host, a plurality of expandable downstream ports for connecting to peripherals, and an outlet for providing a power source, said USB hub comprising:
a housing, said upstream ports and said downstream ports being arranged about said housing;
said housing having at least one groove in which a rotatable USB connection port is docked, said groove extending along an outer surface of said housing and being defined by a concave surface for mating with a convex surface of a peripheral device.

6. The improved USB hub as claimed in claim 5, wherein said groove extends from a front of said housing to a rear of said housing.

7. The improved USB hub as claimed in claim 5, wherein said groove includes a first portion with a deeper groove in which the rotatable USB connection port is docked and a second portion with a shallower groove in which said peripheral device is docked.
